(19) United States
(12) Patent Application Publication
(10) Pub. No.: US 2008/0036606 A1
(43) Pub. Date: Feb. 14, 2008

(54) COMMODITY MANAGING ANTENNA AND CONTROL METHOD OF THE SAME

(75) Inventors: Akio Kuramoto, Tokyo (JP); Kosuke Tanabe, Tokyo (JP); Kazunaga Kanai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/675,504

(22) Filed: Feb. 15, 2007

(30) Foreign Application Priority Data
Feb. 17, 2006 (JP) 2006-041318

(51) Int. Cl. G08B 13/14

(52) U.S. Cl. 340/572.7

(57) ABSTRACT

To suppress a loss in the operation due to electromagnetic coupling of a plurality of antenna elements which boot up reading/writing action of RFID tags that are attached to a large number of densely placed commodity media. A commodity managing antenna for booting up reading/writing action of RFID tags attached to commodity media that are densely stored on a shelf comprises: a plurality of loop-type antenna elements arranged in parallel at a constant interval on the shelf where the commodity media are densely stored; a first switch for selectively supplying electricity to one of the antenna elements; and a plurality of second switches inserted to each loop of the antenna elements which, when one of the antenna elements to which the electricity is supplied by the first switch is resonating, electrically disconnect the loops of remaining antenna elements so that those antenna elements become non-resonant.

### BACKGROUND OF THE INVENTION

1. Field of the Invention

The present invention relates to a reader/writer antenna for RFID, which boots up reading/writing action with respect to RFID (Radio Frequency Identification) tags. More specifically, the present invention relates to a commodity managing antenna and a control method thereof for managing the commodities by booting up reading/writing action with respect to RFID tags pasted on each of a large number of densely placed commodities.

2. Description of the Related Art

Recently, there has been proposed an RFID system which manages a large number of densely placed commodity media such as documents, books, CDs (Compact Disks), DVDs (Digital Versatile Disks) by using RFID tags. This will be described below by referring to the case of using books and documents as the commodity media.

FIG. 7 is a perspective view for showing an example of a commodity managing antenna. As shown in FIG. 7, the commodity managing antenna is provided to a bookshelf 500 where the books and documents with the RFID tags pasted thereon are densely stored.

The commodity managing antenna is constituted with a single antenna element 900. The antenna element 900 is a reader/writer antenna for RFIDs for booting up reading/writing action with respect to line densely placed RFID tags, which is capable of instantly detecting, for example, the presence of books and documents stored on the bookshelf 500.

The antenna element 900 is constituted with a loop-type conductor 901, a capacitor 902, and a feed conductor 903. The loop-type conductor 901 is a closed loop-type conductor, and the capacitor 902 is inserted in the middle thereof in series. The feed conductor 903 is connected to an arbitrary position of the loop-type conductor 901, and connected to a coaxial central conductor of a coaxial cable 905. A coaxial outer conductor of the coaxial cable 905 is connected to the loop-type conductor 901.

The number of densely placed RFID tags the commodity managing antenna can boot up for reading/writing action is only about thirty. With the above-described commodity managing antenna, even if the number of densely placed RFID tags is increased through attaching a plurality of antenna elements 900 to the bookshelf 500 and activating them, there may face such an issue that, as will be described later, a good operation may be disturbed due to electromagnetic coupling generated between the antenna elements 900. Specifically, even when a single antenna element 900 can boot up thirty RFID tags, if the electromagnetic coupling is generated between two antenna elements 900, the number of RFID tags that can be boot up for reacting/writing action by employing two antenna elements 900 does not simply double up to sixty but increases to about forty at the most.

With such commodity managing antenna, for booting up reading/writing action of nearly a hundred pieces of densely placed RFID tags, for example, it is necessary to consider the loss in the operations caused due to the electromagnetic coupling of the plurality of antenna elements 900. Thus, the number of antenna elements 900 to be placed becomes increased, which is not practical.

Therefore, desired is a commodity managing antenna with which there is no loss generated in the operations due to the electromagnetic coupling of the plurality of antenna elements 900 which boot up reading/writing action of the densely placed RFID tags.

In regards to the commodity managing antenna using such reader/writer antenna for RFIDs, there are conventional techniques described below.

Conventionally, in order to achieve proper data communication between the antenna pattern and IC cards by providing the optimum matching state with those IC cards regardless of the distance between the IC cards to be electromagnetically coupled, and the kinds and the number of the IC curds, there is disclosed a following technique (for example, see Japanese Unexamined Patent Publication 2001-024413 (Patent Literature 1)). In this technique, when an IC card is electromagnetically coupled to an antenna pattern, a matching-state monitoring part detects the voltage level of a matching circuit and outputs it to a gate array. The gate array, upon receiving an input of the detected level from the matching-state monitoring part, compares the voltage level and a voltage level that is set in advance. When both levels are inconsistent, a switch control part is driven to close/open the loop of the loop pattern of the antenna in order to attain the optimum matching state with the IC card.

Patent Literature 1 described above optimizes the matching state between the antenna pattern and the IC card, however, it is not a technique for dealing with a loss in the operation generated due to the electromagnetic coupling of a plurality of antenna elements which boot up reading/writing action of RFID tags that are placed densely.

Further, there is conventionally disclosed a technique (for example, Japanese Unexamined Patent Publication 2003-072919 (Patent Literature 2)) to propose a commodity managing system, a non-contact identifying method, an antenna unit, and a commodity managing shelf, which are capable of accurately receiving information stored in radio tags that are provided to commodities stored on the shelf without using hands while greatly reducing the labor regained for managing the commodities, the labor costs, and work time. In this technique, a commodity managing system comprises: sections for keeping the commodities; radio tags capable of storing characteristic information and capable of non-contact communication, which are provided to the commodities stored in the sections; an antenna for communicating with the radio tags without contact; and a managing device for managing the characteristic information by relating it to the commodities based on the result of communication through the antenna. For such commodity managing system, a plurality of the antennae are provided within the section, and a switching device is provided for switching the antenna to be in communicating action among a plurality of the provided antennas.

Patent Literature 2 described above switches the antenna to be in communicating action among the plurality of provided antennas, however, it is not a technique for dealing with a loss in the operation generated due so the electromagnetic coupling of a plurality of antenna elements which boot up reading/writing action of RFID tags that are placed densely, as in the above-described case.

Furthermore, there is conventionally disclosed a technique (for example, Japanese Unexamined Patent Publication 2005-086419 (Patent Literature 3)) to achieve secure communication with electromagnetic-guidance RFID elements even when an arbitrary number of RFID elements reside close from each other or overlap on one another. This technique provides a data transmitting/receiving system which carries out reading/writing of data with respect to RFIDs. The oysters comprises: an arbitrary number of electromagnetic-guidance RFID elements; a reader/writer having an electromagnetic-guidance active antenna; and a passive antenna having an adjusting part that can adjust a resonance frequency gradually or continuously.

Patent Literature 3 described above can achieve secure communication between the RFID elements even when an arbitrary number of RFID elements reside close from each other or overlap on one another, however, it is not a technique for dealing with a loss in the operation generated due to the electromagnetic coupling of a plurality of antenna elements which boot up reading/writing action of RFID tags that are placed densely, as in the above-described cases.

Furthermore, in order to securely manage the commodities having thin thickness with respect to the arranged direction on a shelf, there is disclosed a commodity managing system which manages commodities stored on a shelf using RFID media, wherein coil-type antennas, which read out information from IC tags through resonating with the IC tags pasted on books, are provided on a book shelf that is sectioned in the direction of arranging the books (for example, Japanese Unexamined Patent Publication 2005-343608 (Patent Literature 45)).

Patent Literature 4 described above switches a plurality of coil-type antennas in order, however, it is not a technique for dealing with a loss in the operation generated due to the electromagnetic coupling of a plurality of antenna elements which boot up reading/writing action of RFID tags arranged densely, as in the above-described cases.

Moreover, in order to provide a loop antenna system and a radio communication system which can flexibly correspond to the application environments and the use purpose while securing the accuracy of data transmission/reception, there is provided a following technique (for example, Japanese Unexamined Patent Publication 2005-347794 (Patent Literature 5)). In the loop antenna system of thus technique, a plurality of loop antennas are arranged in a straight line of a first plane by shifting the positions, wherein the array of the plurality of loop antennas include a normal line of the first plane and the array can be electromagnetically coupled with radio tags having, as an antenna-coil face, a second plane whose normal-line direction is the above-described straight-line direction. The radio communication system of this technique comprises the radio tags, and a radio-tag access device for accessing to the radio tags, wherein the loop antenna system described above is applied as the antenna elements of the radio-tag access device.

Patent Literature 5 described above comprises a plurality of loop antennas in an array, however, it is not a technique for dealing with a loss in the operation generated due to the electromagnetic coupling of a plurality of antenna elements which boot up reading/writing action of RFID tags that are placed densely, as in the above-described cases.

### SUMMARY OF THE INVENTION

In view of the aforementioned issues, the object of the present invention is to provide a commodity managing antenna which generates no loss in the operation clue to electromagnetic coupling of a plurality of antenna elements which boot up reading/writing action of RFID tags that are attached to a large number of densely placed commodity media.

In order to overcome the aforementioned issues, the present invention provides a commodity managing antenna for booting up reading/writing action of RFID tags attached to commodity media that are densely stored on a shelf comprises: a plurality of loop-type antenna elements arranged in parallel at a constant interval on the shelf where the commodity media are densely stored; a first switch for selectively supplying electricity to one of the antenna elements; and a plurality of second switches inserted to each loop of the antenna elements which, when one of the antenna elements to which the electricity is supplied by the first switch is resonating, electrically disconnect the loops of remaining antenna elements so that those antenna elements become non-resonant.

Further, a resonance frequency for allowing the selected antenna element to resonate is a frequency that is adjusted to resonate under a state where the RFID tags attached to the commodity media to be stored are densely placed. Furthermore, when the shelf for keeping the commodity media is formed with a magnetic material, spacers are provided on inner sides of both ends of the shelf, and the spacers are formed with at least one of materials selected from a dielectric material, a nonmetal material, and a nonmagnetic material.

Moreover, as each of the second switches of the plurality of antenna elements, a diode is inserted to a loop at a positron between points where a coaxial central conductor and a coaxial outer conductor of a coaxial cable which supplies electricity are connected to the loop, and there is provided a bias tee that is constituted with a coil for applying a bias voltage to the coaxial central conductor of the coaxial cable and a capacitor for preventing the added bias voltage from being flown to an opposite side of the loop.

Further, boot-up of reading/writing action is carried out on the RFID tags that are attached to at least one of the kinds selected from books, documents, CDs, DVD media, clothes, and food products as the commodity media that are densely stored on the shelf.

Furthermore, the present invention provides a commodity managing antenna control method for booting up reading/writing action with respect to RFID tags attached to commodity media that are stored densely on a shelf, which comprises the steps of:

selectively supplying electricity to one of a plurality of loop-type antenna elements that are arranged in parallel at a constant interval in a storage space where the commodity media are densely placed; and

when electricity is supplied selectively to one or the plurality of antenna elements, loops of other antenna elements than the antenna element to which the electricity is selectively supplied are electrically disconnected so that the other antenna elements become non-resonant.

As described above, in the present invention, electricity is selectively supplied to one of the plurality of loop-type antenna elements that are arranged in parallel at a constant interval on a shelf where the commodity media are densely stored. When the electricity is selectively supplied to one of the plurality of the antenna elements, the loops of the other antenna elements than the antenna element to which the electricity is selectively supplied are electrically disconnected for making the other antenna elements non-resonant. Therefore, there is no loss generated in the operation due to the electromagnetic coupling of a plurality of antenna elements that are provided for the RFID tags placed densely. Thus, the operation state of each antenna element for a large number of densely placed RFID tags can be set as the best condition, thereby improving the recognition rate of the RFID tags.

The resonance frequency for resonating one of the antenna elements is set to be the frequency that is adjusted to resonate under the state where the RFID tags attached to the commodity media to be stored are densely placed. Thus, it becomes easier to adjust the resonance frequency for the plurality of antenna elements.

When the shelf for keeping the commodity media is formed with a magnetic material, spacers are provided on the inner sides of both ends of the shelf. The spacers are formed with at least one of materials selected from a dielectric material, a paper material, a nonmetal material, and a nonmagnetic material. Therefore, it is possible to ease the influence of the material that constitutes the bookshelf.

### BRIEF DESCRIPTION OF THE DRAWINGS

FIG. 1 is a perspective view for showing the schematic structure of a commodity managing antenna according to an embodiment of the present invention, in which books and documents arc used as the commodity media;

FIG. 2 is a perspective view for describing action of the commodity managing antenna shown in FIG. 1;

FIG. 3 is a flowchart for describing the control action of a coaxial switch 501 and switches 103, 203 of the commodity managing antenna shown in FIG. 1 or FIG. 2;

FIG. 4 is a perspective view for showing the schematic structure of a commodity managing antenna according to a modification example of FIG. 1, in which books and documents are used as the commodity media;

FIG. 5 is a perspective view for showing the schematic structure of a commodity managing antenna according to a modification example of FIG. 2, in which books and documents are used as the commodity media;

FIG. 6 is a perspective view for showing another example of the inner structure which corresponds to the antenna elements 100, 200, and 300 of FIG. 1, FIG. 2 and FIG. 4; and

FIG. 7 is a perspective view for showing the schematic structure of a commodity managing antenna according to the related art.

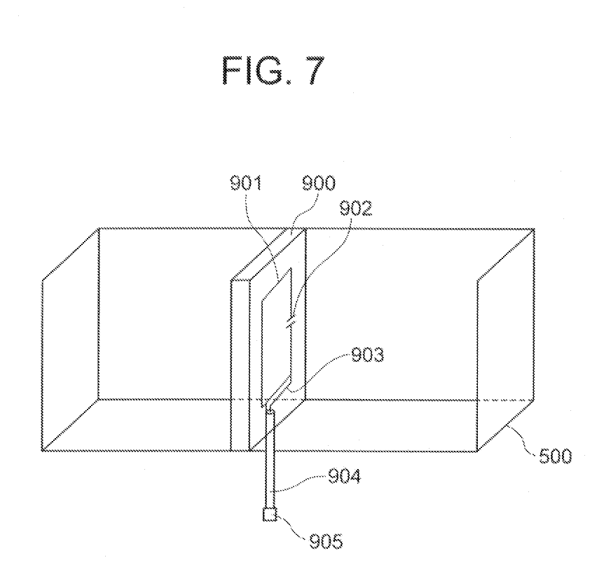

### DETAILED DESCRIPTION OF THE PREFERRED EMBODIMENTS

An embodiment of the present invention will be described hereinafter by referring to the accompanying drawings.

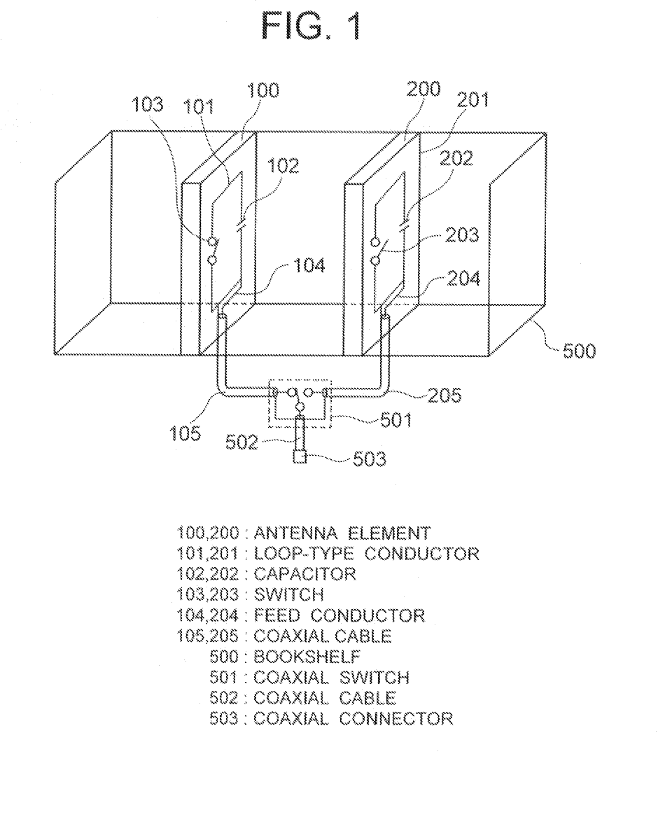

FIG. 1 is a perspective view for showing the schematic structure of a commodity managing antenna according to the embodiment of the present invention, in which books and documents are used as the commodity media. In FIG. 1, books and documents to which RFID (Radio Frequency Identification) tags are pasted are stored on a bookshelf 500 as the commodity media.

As shown in FIG. 1, two antenna elements 100 and 200 are disposed at a constant interval as the commodity managing antennas, i.e. reader/writer antennas for RFIDs. Coaxial cables 105, 205 of the antenna elements 100, 200 are connected to a coaxial cable 502 through a coaxial switch 501, to which a coaxial connector 503 is added. The coaxial switch 501 switches connection between a coaxial central conductor of the coaxial cable 502 and coaxial central conductors of the coaxial cables 105, 205. Therefore, when the coaxial switch 501 connects she coaxial central conductor of the coaxial cable 502 to the coaxial central conductor of the coaxial cable 105, the coaxial central conductor of the coaxial cable 502 and the coaxial central conductor of the coaxial cable 205 are electrically isolated. When the coaxial switch 501 connects the coaxial central conductor of the coaxial cable 502 to the coaxial central conductor of the coaxial cable 205, the coaxial central conductor of the coaxial cable 502 and the coaxial central conductor of the coaxial cable 105 are electrically isolated. A coaxial outer conductor of the coaxial cable 502 and coaxial outer conductors of the coaxial cables 105, 205 are electrically connected irrespective of the open/close control of the coaxial switch 501. However, like the case of the coaxial central conductors, connection between the coaxial outer conductor oaf the coaxial cable 502 and the coaxial outer conductors of the coaxial cables 105, 205 may selectively be switched by the coaxial switch 501.

It is important to adjust the antenna elements 100 and 200 such that the resonance frequency becomes consistent with RF signals under the state where the bookshelf 500 is filled with the RFID tags. This makes it easier to adjust the resonance frequency for the antenna elements 100 and 200. The outer frame of the antenna element 100 is constituted with a case made of a dielectric material such as plastic, and a loop-type conductor 101, a capacitor 102, a switch 103, and a feed conductor 104 are arranged therein.

The loop-type conductor 101 is a conductor of a closed-loop type. In the middle of the loop-type conductor 101, the capacitor 102 is inserted in series and the switch 103 is inserted in series as well. The feed conductor 104 is connected to an arbitrary position of the loop-type conductor 101, which is disposed in parallel to the loop-type conductor 101 with a proper distance and connected to the coaxial central conductor of the coaxial cable 105. In this case, the coaxial outer conductor of the coaxial cable 105 is connected to the loop-type conductor 101.

The antenna element 200 has the same structure as that of the antenna 100. The outer frame is constituted with a case made of a dielectric material such as plastic, and a loop-type conductor 201, a capacitor 202, a switch 203, and a feed conductor 204 are arranged therein. The loop-type conductor 201 is a conductor of a closed-loop type. In the middle of the loop-type conductor 201, the capacitor 202 is inserted in series and the switch 203 is inserted in series as well.

The feed conductor 204 is connected to an arbitrary position of the loop-type conductor 201, which is disposed in parallel to the loop-type conductor 201 with a proper distance and connected to the coaxial central conductor of the coaxial cable 205. In this case, the coaxial outer conductor of the coaxial cable 205 is connected to the loop-type conductor 201. The coaxial switch 501 controls to choose either one of the coaxial cables 105, 205, and supplies the electricity to the either one of the antenna elements 100 and 200 from the coaxial cable 502. Further, the switches 103, 203 of the antenna elements 100, 200 perform, such a control that the loop, which is nth selected to be supplied with the electricity by the control of the coaxial switch 501, becomes electrically cut and non-resonant.

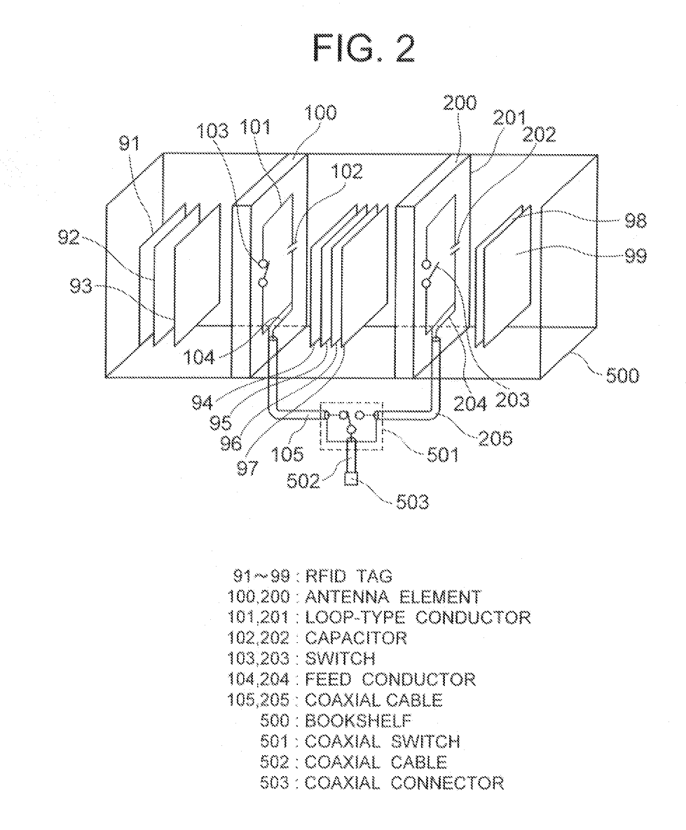

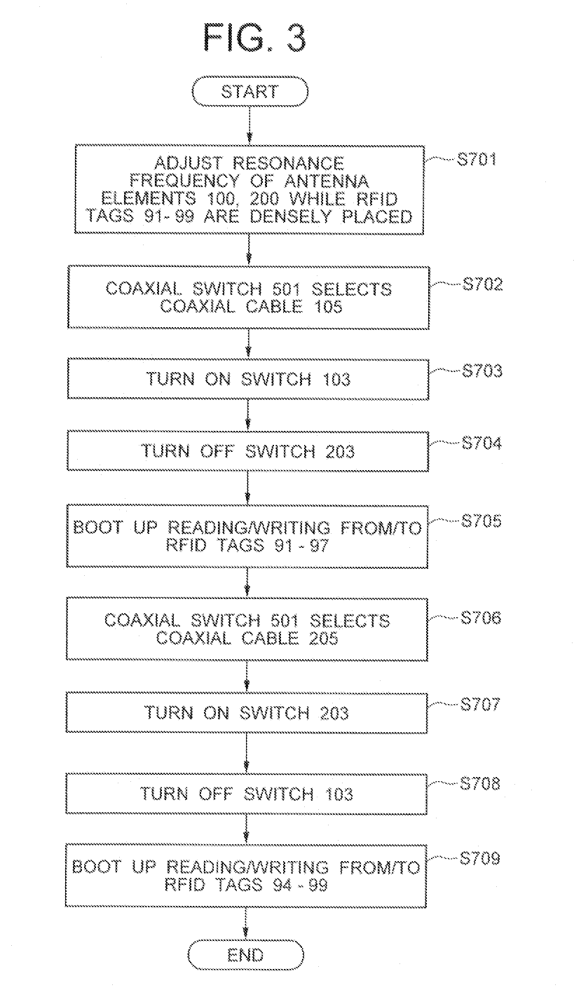

FIG. 2 is a perspective view for describing action of the commodity managing antenna shown in FIG. 1, and FIG. 3 is a flowchart for describing the control action of the coaxial switch 501 and the switches 103, 205 of the commodity managing antenna shown in FIG. 1 or FIG. 2.

FIG. 2 is a case of using the two antenna elements 100 and 20. The storage space of the bookshelf 500 is partitioned into three by the two antenna elements 100 and 200. RFID tags 91-99 are pasted on the books or documents as the commodity media, which are densely stored within the storage space of the bookshelf 500 partitioned by the two antenna elements 100 and 200.

For managing the books or the documents within the bookshelf 500 by using the antenna elements 100 and 200, the resonance frequencies of the two antenna elements 100 and 200 are adjusted to resonate when the RFID tags 91-99 are densely placed (step S701 in FIG. 3).

Then, the coaxial cable 105 is selected by operating the coaxial switch 501, and the coaxial cable 502 is connected to the antenna element 100 to enable supply of the electricity from the coaxial cable 502 to the antenna element 100 (step S702 in FIG. 3).

Then, the switch 103 of the antenna element 100 is remained in an on state (step 2703 in FIG. 3). Thus, when the electricity is supplied from the coaxial cable 502, the antenna element 100 becomes capable of resonation. Meanwhile, the switch 203 of the antenna element 200 is turned off to cut the loop electrically (step S704 in FIG. 3). Thus, the antenna element 200 becomes incapable of resonation.

When an RF (radio frequency) signal is inputted from the coaxial connector 503 to the antenna element 100, the antenna element 100 resonates and a magnetic field is generated therein, thereby booting up reading and writing actions of the RFID tags 91-97 that are close to the antenna element 100 (step S705 in FIG. 3). In this case, there is no resonant phenomenon generated in the antenna element 200, so that reading/writing action with respect to the RFID tags 98 and 99 close to the antenna element 200 are not booted up. Depending on the intensity of the magnetic field generated in the antenna element 100 (when the intensity is weak), boot-up of reading/writing action with respect to the RFID tag 97 or the RFID tags 90 and 97 among the RFID tags close to the antenna element 100 may not be carried out due to the distance.

The coaxial cable 205 is selected through operating the coaxial switch 501 at the point where the reading/writing action is completed between the antenna element 100 and the RFID tags stored within the storage space of the bookshelf 500 that is partitioned by the antenna element 100 (step S706 in FIG. 3). When the coaxial cable 205 is selected through the operation of the coaxial switch 501, the coaxial cable 502 is connected to the antenna element 100. With this, the electricity can be supplied from the coaxial cable 502 to the antenna element 200.

Then, the switch 203 of the antenna element 200 is turned on (step S703 in FIG. 3). Thus, when the electricity is supplied from the coaxial cable 502, the antenna element 200 becomes capable of resonation. Meanwhile, the switch 103 of the antenna element 100 is turned off to cut the loop electrically (step S708 in FIG. 3). Thus, the antenna element 100 becomes incapable of resonation.

Through the RF (radio frequency) signals inputted from the coaxial connector 503, the antenna element 200 resonates and a magnetic field is generated therein, thereby booting up reading/writing action with respect to the RFID tags 94-99 (step S709). In this case, there is no resonant phenomenon generated in the antenna element 100, so that reading/writing action with respect to the RFID tags 91-93 close to the antenna element 100 is not booted up. Depending on the intensity of the magnetic field generated in the antenna element 200 (when the intensity is weak), boot-up of reading/writing action with respect so the RFID tag 94 or the RFID tags 94 and 95 among the RFID tags close to the antenna element 200 may not be carried out due to the distance.

Therefore, it is possible with the embodiment to boot up reading/writing action with respect to the RFID tags 96, 97 and the RFID tags 94, 95 which are stored in the storage space partitioned by the antenna elements 100, 200 through selectively switching the antenna elements 100 and 200.

In the embodiment, the switch 103 is turned on to set the antenna element 100 to be capable of resonation, and the switch 203 is turned off to set the antenna element 200 to be capable of non-resonation. Further, the switch 103 is turned off to set the antenna element 100 to be capable of non-resonation, and the switch 203 is turned on to set the antenna element 200 to be capable of resonance. The reason will be described below.

When there is a resonant circuit that resonates with the same radio frequency, the antenna elements 100 and 200 face the following issue.

(1) There is generated electromagnetic coupling between the resonant circuit, which causes shift in the resonance frequency including the coupled system so that the magnetic field of sufficient intensity cannot be generated.

(2) The magnetic field distribution in the space is changed and unbalanced, so that boot-up of reading/writing action with respect to the RFID tags which are on the left and right sides cannot be performed sufficiently.

That is, in the case of FIG. 1 or FIG. 2, when the antenna element 200 is set to a resonant state while the antenna element 100 is resonating or, inversely, when the antenna element 100 is set to a resonant state while the antenna element 200 is resonating, the antenna, element 100 and the antenna element 200 are electromagnetically coupled and the resonance frequency in terms of the coaxial cable 105 or 205 is shifted due to the influence of the mutual inductance by caused the coupling. As a result, the antenna element 100 or 200 cannot concert the RF signals to a sufficiently large magnetic field.

Further, the generated magnetic fields are concentrated between the antenna element 100 and the antenna element 200, and it is hard to he distributed on the left and right sides and the periphery of the antenna elements 100, 200. Thus, it is not possible to boot up a sufficient reading/writing action with respect to the RFID tags which are on both sides of the antenna elements 100 and 200. Therefore, with the present embodiment, there is no loss generated in the operation due to the electromagnetic coupling of a plurality of antenna elements that are provided for the RFID tags placed densely. Thus, the operation state of each antenna element for a large number of densely placed RFID tags can be set as the best condition, thereby improving the recognition rate of the RFID tags.

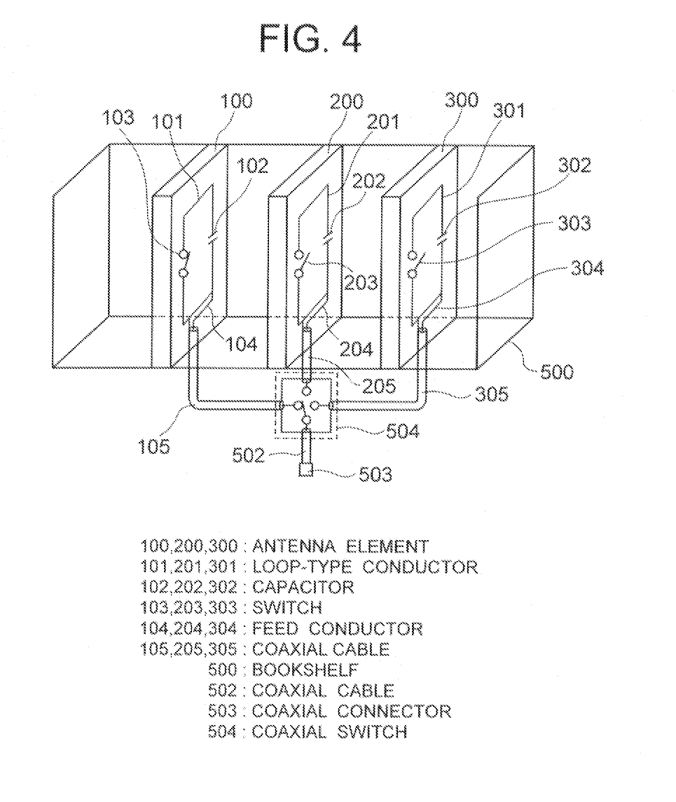

FIG. 4 is a perspective view for showing the schematic structure of a commodity managing antenna according to a modification example of FIG. 1, in which books and documents are used as the commodity media. In the embodiment shown in FIG. 4, three loop-type antenna elements 100, 200, 300 are disposed to the bookshelf 500 at a constant interval, coaxial cables 105, 205, 305 for supplying electricity to each of the antenna elements 100, 200, 300 are connected to the coaxial cable 502 through a coaxial switch 504, to which the coaxial connector 503 is added.

The antenna elements 100 sod 200 are in the structure as described above. Further, the antenna element 300 also has the same structure as that of the antenna elements 100 and 200. The outer frame is constituted with a case made of a dielectric material such as plastic, and a loop-type conductor 301, a capacitor 302, a switch 303, and a feed conductor 304 are arranged therein, which are connected in the same manner as the case of the antenna elements 100 and 200. The coaxial cables 105, 205, 305 for supplying the electricity to the antenna elements 100, 200, 300 are connected to the coaxial switch 504 such that one of the cables can be selected, and the coaxial cable 502 is connected to the coaxial switch 304.

Through the operation of the coaxial switch 504, the coaxial cable 502 can be connected selectively to one of the coaxial cables 105, 205, and 305.

It is possible with the embodiment shown in FIG. 4 to boot up reading/writing actions of ninety RFID tags that are placed densely at an interval of about 8 mm, when three antenna elements with the RF power of 4 W are disposed at an interval of about 25 cm at 13.56 MHz, for example.

Referring to FIG. 4, the case of partitioning the storage space by the three antenna elements is described. However, it is not limited to that case. In general, the following structure is also possible.

(1) A plurality of loop-type antenna elements are connected in parallel;

(2) The loop-type antenna elements are switched as necessary;

(3) The loop of the unused loop-type antenna element is cut electrically; and

(4) The resonance frequency of the loop-type antenna elements to be used is adjusted to resonate when the RFID tags to be used are densely provided.

In this manner, the plurality of antenna elements disposed to boot up reading/writing actions with respect to a large number of RFID tags are operated in order. For not generating resonation the switches of the other antennas are turned off when one of the antenna elements is in action, so that she other antenna element is not electrically coupled. With this, operation state of each antenna element can be set as the best condition.

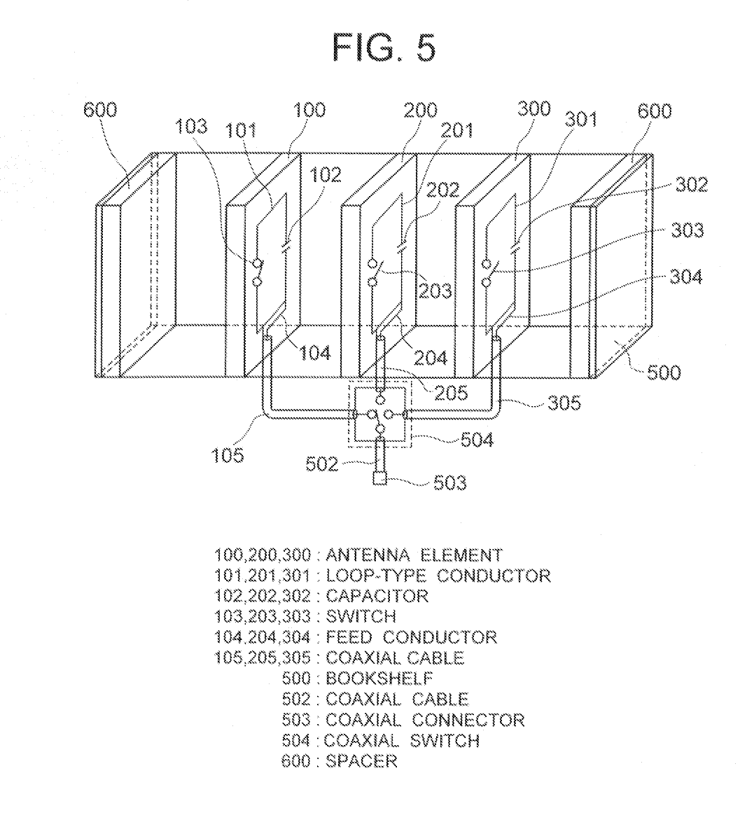

FIG. 5 is a perspective view for showing the schematic structure of a commodity managing antenna according to a modification example of FIG. 2, in which books and documents are used as the commodity media. In the embodiment shown in FIG. 5, spacers 600 are disposed on the inner sides of both ends of the bookshelf 500. The spacer 600 is formed with a dielectric material such as plastic, paper material, nonmetal material such as foaming polystyrol, or a nonmagnetic material.

When the bookshelf 500 is formed with a magnetic material such as metal or iron, boot-up of reading/writing action with respect to the RFID tags placed on the both ends of the bookshelf 500 may become difficult.

In the embodiment shown in FIG. 5, the spacers 600 are presided for easing the influence of the material that constitutes the bookshelf 500.

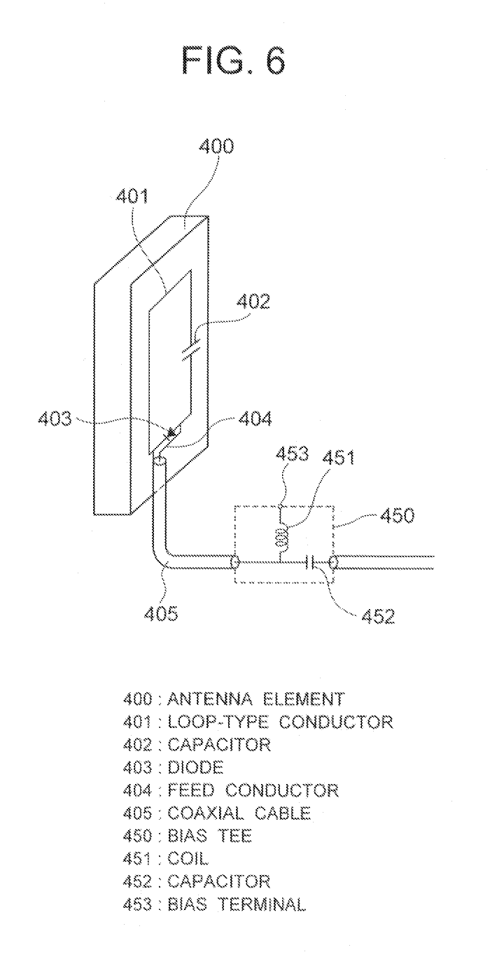

FIG. 6 is a perspective view for showing another example of the inner structure which corresponds to the antenna elements 100, 200, and 300 of FIG. 1, FIG. 2, and FIG. 4. An antenna element 400 shown in FIG. 6 corresponds to the antenna elements 100, 200, and 300 shown in FIG. 1, FIG. 2, and FIG. 4.

The antenna element 400 shown in FIG. 6 is in a structure in which a capacitor 402 is inserted in series to the middle of a closed loop-type conductor 401, and a diode 403 is inserted in series as well. That is, the switches 103, 203, and 303 in FIG. 1, FIG. 2, and FIG. 4 are changed to the switches using a diode.

Further, a feed conductor 404 is connected to an arbitrary position or a loop-type conductor 401, which is disposed in parallel to the loop-type conductor 401 with a proper distance and connected to the coaxial central conductor of a coaxial cable 405. In this case, the coaxial outer conductor of the coaxial cable 405 is connected to the loop-type conductor. Furthermore, for simplifying the circuit of the bias current, a diode 403 is inserted to cue loop-type conductor 401 at the position between the points where the coaxial central conductor and the coaxial outer conductor of the coaxial cable 405 are connected to the loop-type conductor 401.

A bias tee 450 for applying a direct current to turn on or off the diode 403 in terms of radio frequency is connected to the other one of the coastal cable 405. A coil 451 is connected between the coaxial central conductor and a bias terminal 453 to apply the bias voltage. A capacitor 452 is for preventing the bias currant from flowing to the opposite side via the coaxial central conductor.

For the coaxial switches 501 and 504 in FIG. 1, FIG. 2, and FIG. 4, it is also possible to use diode switch circuits and solid-state switches which are available on the market.

The present invention has been described by referring to the case of using the books and documents as the densely placed commodity media to which the RFID tags are attached. However, it is not limited to that case. The present invention can also be applied to the commodity media suet, as CDs, DVD media, clothes, food products, which are stored densely on shelves.

What is claimed is:

1. A commodity managing antenna for booting up reading/writing action with respect to RFID tags attached to commodity media, comprising:
a plurality of loop-type antenna elements which resonate with a supply of electricity; and switches, wherein
the loop-type antenna elements are provided at positions to partition a storage space where the commodity media are stored, and
the switches control the supply of electricity to the loop-type antenna elements.

2. The commodity managing antenna as claimed in claim 1, wherein each of the loop-type antenna elements comprises a switch for disconnecting its loop.

3. The commodity managing antenna as claimed in claim 1, wherein a resonance frequency that allows the antenna elements to resonate is a frequency that is adjusted to resonate under a state where the RFID tags attached to the commodity media to be stored are densely placed.

4. The commodity managing antenna as claimed in claim 1, wherein: spacers are provided on inner sides of both ends of a shelf that is formed with a magnetic material; and the spacers are formed with at least one of materials selected from a dielectric material, a nonmetal material, and a nonmagnetic material.

5. The commodity managing antenna as claimed in claim 2, wherein, as the switch, of the antenna element, a diode is inserted to the loop at a position between points where a coaxial central conductor and a coaxial outer conductor of a coaxial cable which supplies electricity are connected to the loop, and there is provided a bias tee that is constituted with a coil for applying a bias voltage to the coaxial central conductor of the coaxial cable and a capacitor for preventing the added bias voltage from being flown to an opposite side of the loop.

6. A commodity managing antenna control method for booting up reading/writing action with respect to RFID tags attached to commodity media, comprising the steps of:
selectively supplying electricity to one of a plurality of loop-type antenna elements that are arranged in parallel at a constant interval in a storage apace where the commodity media are placed; and
when electricity is supplied selectively to one of the plurality of antenna elements, loops of other antenna elements than the antenna element to which the electricity is selectively supplied are electrically disconnected so that the other antenna elements become non-resonant.
